(19) United States
(12) Patent Application Publication
(10) Pub. No.: US 2014/0015711 A1
(43) Pub. Date: Jan. 16, 2014

(54) WIRELESS COMMUNICATION SYSTEM AND TIME SYNCHRONIZATION METHOD OF THE SAME

(71) Applicants: Shi-Xian YANG, Tainan City (TW); Wei-Sheng YANG, Taichung City (TW)

(72) Inventors: Shi-Xian YANG, Tainan City (TW); Wei-Sheng YANG, Taichung City (TW)

(73) Assignee: SKYTRAQ TECHNOLOGY, INC., HSINCHU CITY (TW)

(21) Appl. No.: 13/545,664

(22) Filed: Jul. 10, 2012

(51) Int. Cl. H04B 1/7075; G01S 19/43

(52) U.S. Cl. 342/357.26; 375/149; 375/E01.003

(57) ABSTRACT

A wireless communication system having a time synchronization mechanism is provided. The wireless communication system comprises a first receiver and a second receiver. The first receiver tracks a code phase data of a satellite to generate a synchronization data related to a sync phase position and a first receiver phase position corresponding to one of first receiver time pulses. The second receiver comprises a receiving unit, a tracking unit and a computing unit. The receiving unit receives the synchronization data from the first receiver through a network. The tracking unit tracks the code phase data of the satellite to obtain a second receiver phase position corresponding to one of second receiver time pulses. The computing unit performs a time synchronization process with the first receiver and the satellite according to the code phase data, the synchronization data and the second receiver phase position.

### TECHNICAL FIELD

Embodiments of the present invention relate to a communication technology. More particularly, embodiments of the present invention relate to a wireless communication system and a time synchronization method of the same.

### BACKGROUND OF INVENTION

Satellite positioning system (SPS) receivers have been used to provide location, time, timing, and/or frequency reference information. In satellite systems, the clocks in the receivers will have phase mismatch and frequency mismatch with the clocks in the satellites. In order to make the receivers synchronize with the satellites, it is typical to compute the clock bias between the receivers and the satellite. In conventional technology, at least four satellites are used to compute the 3-D (3 dimensional) location and the clock bias of the receivers such that the receivers can synchronize with the satellites. The synchronization process is time-consuming.

Thus, there is a need for an improved wireless communication system and a time synchronization method of the same to provide an accurate and fast time synchronization mechanism.

### BRIEF SUMMARY OF THE INVENTION

Embodiments of the subject invention relate to a method and/or system for performing a time synchronization process on devices in a wireless communication system.

In a specific embodiment, a wireless communication system having a time synchronization mechanism is provided. The wireless communication system comprises a first receiver and a second receiver. The first receiver tracks a code phase data of a satellite to generate a synchronization data related to a sync phase position and a first receiver phase position corresponding to one of first receiver time pulses. The second receiver comprises a receiving unit, a tracking unit and a computing unit. The receiving unit receives the synchronization data from the first receiver through a network. The tracking unit tracks the code phase data of the satellite to obtain a second receiver phase position corresponding to one of second receiver time pulses. The computing unit performs a time synchronization process with the first receiver and the satellite according to the code phase data, the synchronization data and the second receiver phase position.

Various embodiments are illustrated in the figures and description provided herein. It should be understood, however, that the subject invention is not limited to the specific embodiments illustrated in the figures and specifically described herein.

### BRIEF DESCRIPTION OF DRAWINGS

Various embodiments of the present invention are disclosed in the following detailed description and the accompanying drawings.

FIG. 1 is a diagram depicting a wireless communication system in an embodiment of the present invention.

FIG. 2 is a diagram depicting two axes that represent the time line and the code phase line of the wireless communication system respectively in an embodiment of the present invention.

FIG. 3 is a block diagram of the second receiver in an embodiment of the present invention.

FIG. 4 is a diagram depicting the code phase of the wireless communication system 1 in an embodiment of the present invention.

FIG. 5 is a flow chart of a time synchronization method in an embodiment of the present invention.

### DETAILED DISCLOSURE

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It is also to be understood that the terminology used herein is for the purpose of describing particular embodiments of this disclosure only and is not intended to be limiting.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

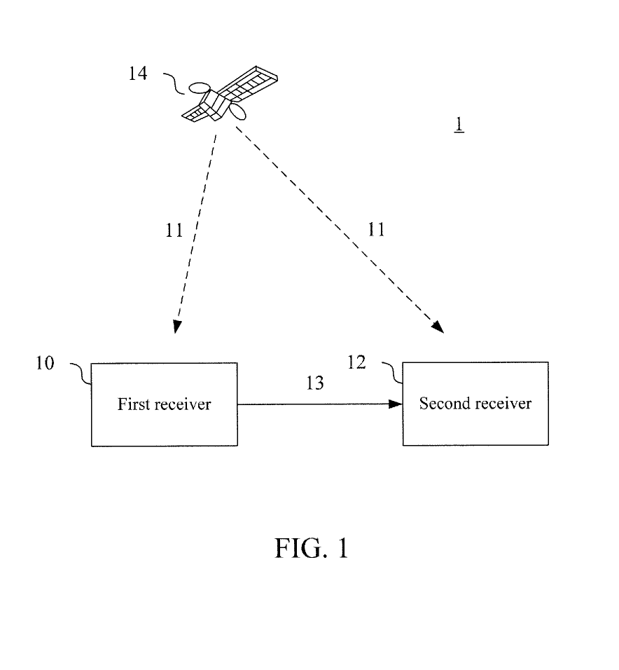

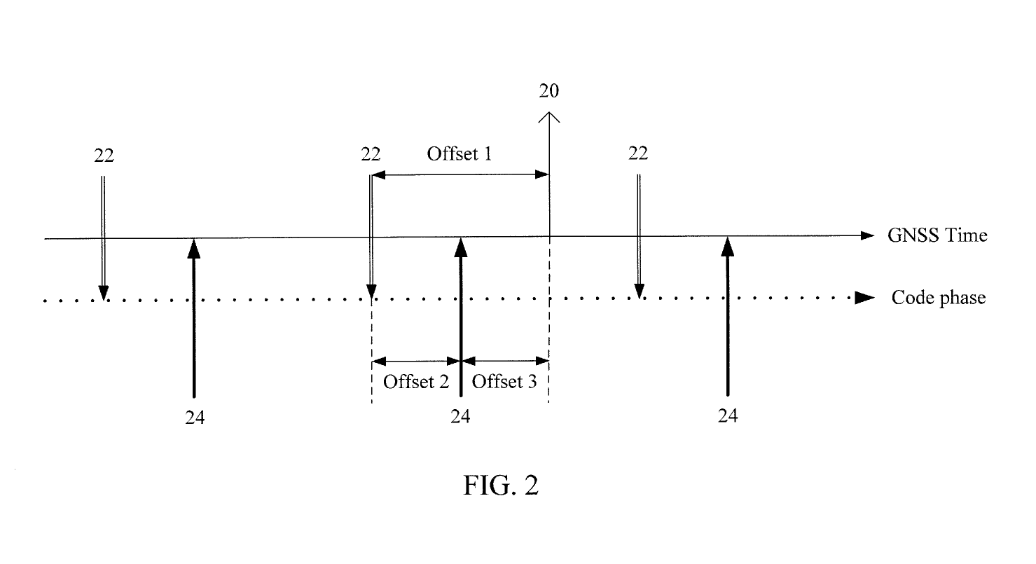

FIG. 1 is a diagram depicting a wireless communication system 1 in an embodiment of the present invention. The wireless communication system 1 comprises a first receiver 10 and a second receiver 12. FIG. 2 is a diagram depicting two axes that represent the time line and the code phase line of the wireless communication system 1, respectively, in an embodiment of the present invention.

In the present embodiment, the first receiver 10 is a server and the second receiver 12 is a client. In an embodiment, both the first receiver 10 and the second receiver 12 can be implemented in a portable electronic device. Both the first receiver 10 and the second receiver 12 can track the signal of a satellite 14.

The first receiver 10 tracks a code phase data 11 of a satellite 14 to generate a synchronization data 13. In an embodiment, the code phase data 11 is a C/A (coarse/acquisition) code data. C/A code is a 1023 “chip” long code, being transmitted with a frequency of 1.023 MHz. A “chip” is the same as a “bit”, and is described by the numbers “one” or “zero”. The C/A code is a pseudo random code (PRN) which looks like a random code but is clearly defined for each satellite. It is repeated every 1023 bits or every millisecond. Therefore each second 1023000 chips are generated.

In the present embodiment, the synchronization data 13 generated by the first receiver 10 is related to a sync phase position corresponding to one of a plurality of sync time pulses and a first receiver phase position corresponding to one of a plurality of first receiver time pulses of a first receiver clock. In an embodiment, the sync phase position can be defined by the first receiver 10 itself. In another embodiment, the sync phase position is a satellite phase position corresponding to one of a plurality of satellite time pulses of a satellite clock and a first receiver phase position corresponding to one of a plurality of first receiver time pulses of a first receiver clock according to the code phase data 11 tracked from the satellite.

During the operation of the first receiver 10, the clock of the first receiver 10 keeps generating its own time pulses (i.e., the first receiver phase position 22 depicted in FIG. 2). Similarly, the clock of the satellite 14 keeps generating time pulses during its operation. In an embodiment, the first receiver 10 can obtain the first receiver phase position 22 that corresponds to one of the first receiver time pulses of the first receiver clock. Further, the phase position 20 depicted in FIG. 2 can be the sync phase position determined by the first receiver 10. A first phase offset (depicted as offset 1 in FIG. 2) is presented between the phase position 20 (sync phase position) and the first receiver phase position 22. Since the phase position 20 (sync phase position) is determined by the first receiver 10, the first phase offset can be easily computed.

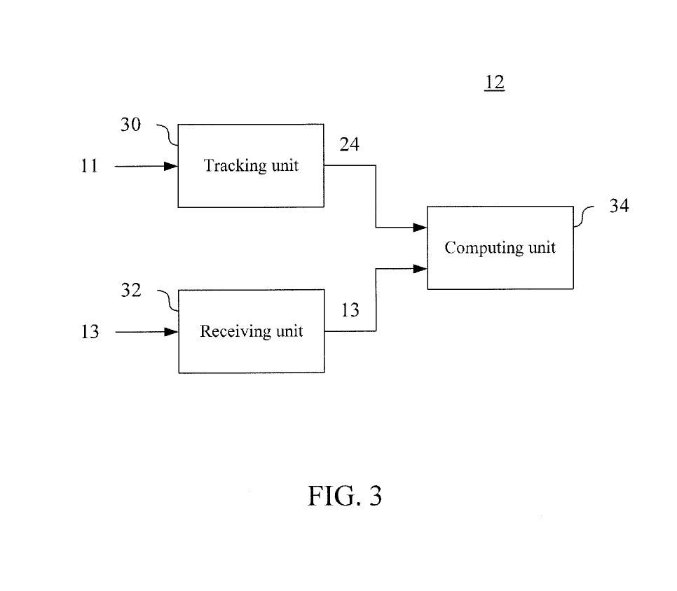

FIG. 3 is a block diagram of the second receiver 12 in an embodiment of the present invention. The second receiver 12 comprises a tracking unit 30, a receiving unit 32 and a computing unit 34.

Similar to the first receiver 10, the tracking unit 30 of the second receiver 12 tracks the code phase data 11 of the satellite 14 to obtain a second receiver phase position 24 depicted in FIG. 2 corresponding to one of a plurality of second receiver time pulses of a second receiver clock. The receiving unit 32 of the second receiver 12 further receives the synchronization data 13 from the first receiver 10 through a network. In different embodiments, the network can be either a wired network or a wireless network.

The computing unit 34 of the second receiver 12 performs a time synchronization process with the first receiver 10 according to the code phase data 11, the synchronization data 13 and the second receiver phase position. In an embodiment, after receiving the synchronization data 13 from the first receiver, the computing unit 34 of the second receiver 12 can directly compute the offset (depicted as offset 2 in FIG. 2) between the first receiver phase position 22 and the second receiver phase position 24 first. The computing unit 34 of the second receiver 12 further computes a second phase offset (depicted as offset 3 in FIG. 2) between the phase position 20 (sync phase position) and the second receiver phase position 24 according to the synchronization data 13. Though the second phase offset cannot be retrieved directly from the code phase data 11, the computing unit 34 of the second receiver 12 can compute the second phase offset by subtracting the first phase offset by the offset between the first receiver phase position 22 and the second receiver phase position 24.

After the second phase offset is computed, the first receiver 10 and the second receiver 12 generate a synchronized time pulse according to the first phase offset and the second phase offset.

Consequently, the second receiver 12 of the wireless communication system 1 of the present invention can quickly perform synchronization with the aid of only one satellite by receiving the synchronization data 13 transmitted from the first receiver 10 through the network. Further, the second receiver 12 can quickly perform synchronization without the aid of ephemeris data and 3-D positioning. In an embodiment, the synchronization process of the present disclosure can accomplish microsecond accuracy.

It is noted that, in an embodiment, the first receiver 10 and the second receiver 12 can track different satellites to perform the synchronization process. For example, the first receiver 10 can track the code phase data of a first satellite (not shown) to generate a synchronization data while the second receiver 12 can track the code phase data of a second satellite (not shown) to obtain a second receiver phase position. The second receiver 12 can further receive the synchronization data through the network and perform the synchronization process according to the synchronization data and the second receiver phase position.

In another embodiment, the first receiver 10 obtains its position relative to the satellite 14 by a procedure of three-dimensional (3-D) fix first. In other words, the first receiver 10 can perform the 3-D fix process by using at least four satellites first to obtain its position relative to the satellite 14. The phase position 20 in FIG. 2 in the present embodiment can be a satellite phase position that corresponds to one of the satellite time pulses. The first receiver 10 can obtain the phase position 20 (satellite phase position) after the 3-D fix by tracking the code phase data 11 of the satellite 14 as shown in FIG. 2. A first phase offset (depicted as offset 1 in FIG. 2) is presented between the phase position 20 (satellite phase position) and the first receiver phase position 22 since the first receiver 10 and the satellite 14 are not synchronized. Hence, by tracking the code phase data 11 of the satellite 14, the first phase offset can be computed according to the phase position 20 (satellite phase position) and the first receiver phase position 22 corresponding to the satellite time pulse and the first receiver time pulse, respectively.

Accordingly, the computing unit 34 of the second receiver 12 depicted in FIG. 3 performs a time synchronization process with the first receiver 10 and the satellite 14 according to the code phase data 11, the synchronization data 13 and the second receiver phase position. In an embodiment, after receiving the synchronization data 13 from the first receiver, the computing unit 34 of the second receiver 12 can directly compute the offset (depicted as offset 2 in FIG. 2) between the first receiver phase position 22 and the second receiver phase position 24 first. The computing unit 34 of the second receiver 12 further computes the second phase offset (depicted as offset 3 in FIG. 2) between the phase position 20 (satellite phase position) and the second receiver phase position 24 according to the synchronization data 13. Though the second phase offset cannot be retrieved directly from the code phase data 11, the computing unit 34 of the second receiver 12 can compute the second phase offset by subtracting the first phase offset by the offset between the first receiver phase position 22 and the second receiver phase position 24.

After the second phase offset is computed, the first receiver 10 and the second receiver 12 generate the synchronized time pulse corresponding to the satellite time pulse according to the first phase offset and the second phase offset.

Consequently, the second receiver 12 of the wireless communication system 1, in accordance with specific embodiments of the present invention, can quickly perform synchronization with the aid of only one satellite by receiving the synchronization data 13 transmitted from the first receiver 10 through the network. Further, the second receiver 12 can quickly perform synchronization without the aid of ephemeris data and 3-D positioning. In an embodiment, the synchronization process, in accordance with specific embodiments of the present invention, can accomplish microsecond accuracy.

In an embodiment, each of the clocks in the first receiver 10 and the second receiver 12 has a clock drift. The clock drift is a hardware problem caused by variation in the crystal frequency due to noise, temperature, aging, voltage change etc. Similar to the calculation of the first receiver phase position 22, the first receiver 10 can compute its first receiver clock drift by tracking the code phase data 11 of the satellite 14 after the 3-D fix of the first receiver 10 as well. However, the second receiver 12 cannot compute its second receiver clock drift since the position of the second receiver 12 is unknown.

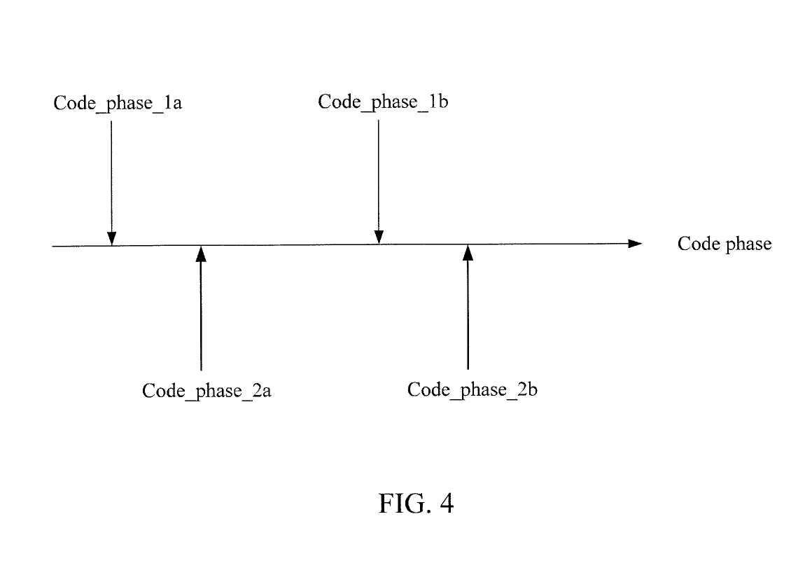

FIG. 4 is a diagram depicting the code phase of the wireless communication system 1 in an embodiment of the present invention. In an embodiment, the synchronization data 13 generated by the first receiver 10 can further comprise the first receiver clock drift and a first receiver phase position difference between neighboring two of the first receiver time pulses, i.e., the Code_phase_{—1}a and the Code_phase_1b depicted in FIG. 4. The tracking unit 30 of the second receiver 12 can obtain a second receiver phase position difference between neighboring two of the second receiver time pulses, i.e., the Code_phase 2a and the Code_phase_2b depicted in FIG. 4, according to the tracking of the code phase data 11 such that the computing unit 34 of the second receiver 12 computes a second receiver clock drift according to the first receiver phase position difference and the second receiver phase position difference.

When the distance from the first receiver 10 to the satellite 14 and the distance from the second receiver 12 to the satellite are substantially the same, such a distance D can be described by the following equation:

$$\begin{matrix}D = ( Code\_phase \_ 1 b - Code\_phase \_ 1 a ) \times ( C + cdrift 1 ) \\ = ( Code\_phase \_ 2 b - Code\_phase \_ 2 a ) \times ( C + cdrift 2 )\end{matrix}$$

wherein C is the speed of the light, cdrift1 is the first receiver clock drift and cdrift2 is the second receiver clock drift. In an embodiment, the speed of light is approximately 3×10⁸ m/s. It is noted that the clock drift described herein is measured by the amount of speed it affect on the signal transmitted by the satellite 14. Hence, the unit of cdrift1 and cdrift2 is m/s (meter per second).

From the above equation, the second receiver 12 can compute its second receiver clock drift quickly and take the clock drift into account to perform the synchronization with higher accuracy.

In an embodiment, when the difference between the distance from the first receiver 10 to the satellite 14 and the distance from the second receiver 12 to the satellite is larger than a predetermine value, the receiving unit 32 of the second receiver 12 can receive rough position information relative to the first receiver 10 to compensate a distance offset of the time synchronization process. In an embodiment, the receiving unit 32 of the second receiver 12 receives the rough position information from the network. For example, the receiving unit 32 of the second receiver 12 can receive the rough position information by using the signals from the base stations of the network, by using Wi-Fi positioning system or by acquiring the position (e.g., the city) corresponding to the IP (Internet Protocol) address of the second receiver 12.

Consequently, the second receiver 12 can use the rough position information to compensate the distance offset of the time synchronization process. For example, when the distance between the first receiver 10 and the second receiver 12 is within 100 meters, the time error generated due to the distance is not larger than 2 μs and the clock offset error is not larger than 5 Hz, When the distance between the first receiver 10 and the second receiver 12 is about 30 km, the time error generated due to the distance is about 20-70 μs and the clock offset error is about 5-20 Hz. When the distance between the first receiver 10 and the second receiver 12 is over 300 km, the time error generated due to the distance would become 80-400 μs and the clock offset error is about 40-180 Hz. Hence, when the distance between the first receiver 10 and the second receiver 12 becomes longer, the error of time and the clock offset is more critical and the compensation is more important.

Due to the transmission of the synchronization data 13 through the network, the network delay becomes a critical issue. In an embodiment, the tracking unit 30 of the second receiver 12 further obtains a frame sync data (not shown) of the satellite 14 from the satellite 14. In an embodiment, the frame sync data comprise TOW (time of week) of the satellite 14. When the network delay is over a specific value, e.g. 20 ms, the second receiver 12 can use the frame sync data from the satellite 14 to calibrate the synchronization process. In another embodiment, the second receiver 12 performs a parity check on the code phase data. When the parity check of the first word of the code phase data fails, the second receiver 12 can use the frame sync data to calibrate the synchronization process, in which the first word of the code phase data described above means the first word of the code phase data tracked by the second receiver 12 after the second receiver 12 tracks the satellite 14. In contrast, when the parity check of the first word of the code phase data passes and the network delay is less than 300 ms, the second receiver 12 does not need the frame sync data to perform synchronization, and at least 1.2 to 6 seconds can be saved during the synchronization process.

It is noted that the wireless communication system 1, in accordance with specific embodiments of the present invention, can be used in the Global Navigation Satellite System (GNSS) such as, but not limited to, the system of GPS, GALILEO, GLONASS, BeiDou (Compass).

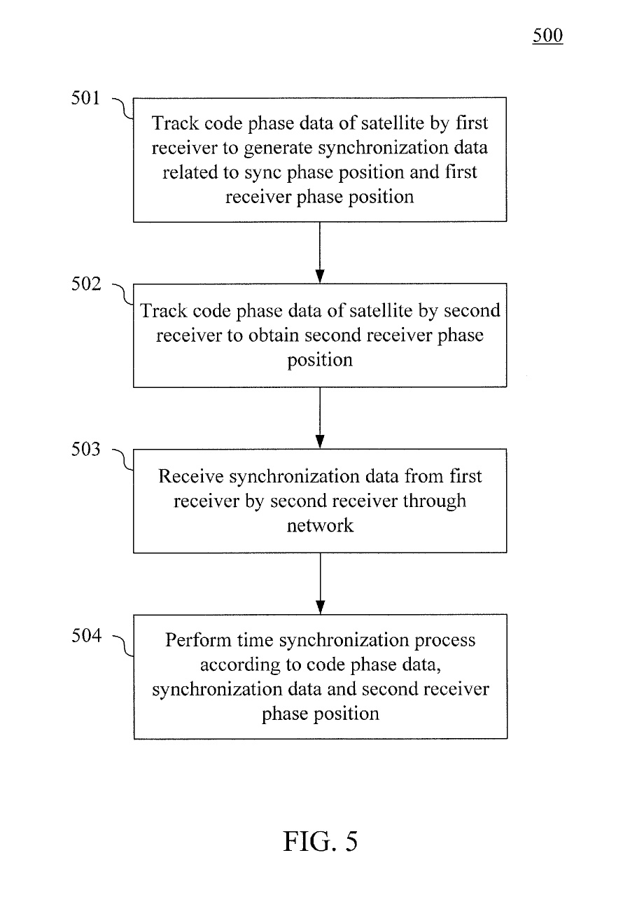

FIG. 5 is a flow chart of a time synchronization method 500 in an embodiment of the present invention. The time synchronization method 500 can be used in the wireless communication system 1 depicted in FIG. 1. The time synchronization method 500 comprises the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 501, a code phase data 11 of a satellite 14 is tracked by a first receiver 10 to generate a synchronization data 13 related to a sync phase position and a first receiver phase position corresponding to one of a plurality of first receiver time pulses of a first receiver clock according to the code phase data 11.

In step 502, the code phase data 11 of the satellite 14 is tracked by a tracking unit 30 of a second receiver 12 to obtain a second receiver phase position corresponding to one of a plurality of second receiver time pulses of a second receiver clock.

In step 503, the synchronization data 13 is received from the first receiver 10 by a receiving unit 32 of the second receiver 12 through a network.

In step 504, a time synchronization process of the second receiver 12 with the first receiver 10 is performed by a computing unit 34 of the second receiver 12 according to the code phase data, the synchronization data and the second receiver phase position.

Aspects of the invention, such as the receiving unit, the tracking unit, and the computing unit, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

It will be apparent to those skilled in the art that various modifications and variations can be made to the structure of the present invention without departing from the scope or spirit of the invention. In view of the foregoing, it is intended that the present invention cover modifications and variations of this disclosure provided they fall within the scope of the following claims.

1. A wireless communication system having a time synchronization mechanism, wherein the wireless communication system comprises:
a first receiver for tracking a code phase data of a satellite to generate a synchronization data related to a sync phase position corresponding to one of a plurality of sync time pulses and a first receiver phase position corresponding to one of a plurality of first receiver time pulses of a first receiver clock according to the code phase data; and
a second receiver comprising:
a receiving unit for receiving the synchronization data from the first receiver through a network;
a tracking unit for tracking the code phase data of the satellite to obtain a second receiver phase position corresponding to one of a plurality of second receiver time pulses of a second receiver clock; and
a computing unit for performing a time synchronization process with the first receiver according to the code phase data, the synchronization data and the second receiver phase position.

2. The wireless communication system of claim 1, wherein the first receiver generates the synchronization data by tracking the code phase data of the satellite after obtaining a position of the first receiver relative to the satellite by a procedure of three-dimensional (3-D) fix and the computing unit performs the time synchronization process with the first receiver and the satellite according to the code phase data, the synchronization data and the second receiver phase position, in which the sync phase position is a satellite phase position corresponding to one of a plurality of satellite time pulses of a satellite clock.

3. The wireless communication system of claim 1, wherein the synchronization data comprises a first phase offset between the sync phase position and the first receiver phase position, the computing unit further computes a second phase offset between the sync phase position and the second receiver phase position according to the synchronization data.

4. The wireless communication system of claim 3, wherein the first and the second receivers further generate a synchronized time pulse corresponding to the sync time pulse according to the first phase offset and the second phase offset.

5. The wireless communication system of claim 2, wherein the synchronization data further comprises a first receiver clock drift and a first receiver phase position difference between neighboring two of the first receiver time pulses and the tracking unit obtains a second receiver phase position difference between neighboring two of the second receiver time pulses according to the tracking of the code phase data and the computing unit further computes a second receiver clock drift according to the first receiver phase position difference and the second receiver phase position difference.

6. The wireless communication system of claim 1, wherein the receiving unit further receives rough position information relative to the first receiver from the network to compensate a distance offset of the time synchronization process.

7. The wireless communication system of claim 1, wherein the tracking unit further obtains a frame sync data of the satellite from the satellite such that the second receiver performs the time synchronization process according to the code phase data, the synchronization data, the second receiver phase position and the frame sync data when a delay of the network is larger than a specific value.

8. The wireless communication system of claim 1, wherein the tracking unit further obtains a frame sync data of the satellite from the satellite such that the second receiver performs the time synchronization process according to the code phase data, the synchronization data, the second receiver phase position and the frame sync data when a parity check of first word of the code phase data fails.

9. A time synchronization method, comprising:
tracking a code phase data of a satellite to generate a synchronization data by a first receiver related to a sync phase position corresponding to one of a plurality of sync time pulses and a first receiver phase position corresponding to one of a plurality of first receiver time pulses of a first receiver clock according to the code phase data;
tracking the code phase data of the satellite by a second receiver to obtain a second receiver phase position corresponding to one of a plurality of second receiver time pulses of a second receiver clock;
receiving the synchronization data from the first receiver by the second receiver through a network; and
performing a time synchronization process of the second receiver with the first receiver by the second receiver according to the code phase data, the synchronization data and the second receiver phase position.

10. The time synchronization method of claim 9, wherein the synchronization data is generated by tracking the code phase data of the satellite by the first receiver after obtaining a position of the first receiver relative to the satellite by a procedure of three-dimensional (3-D) fix and the time synchronization process is performed by the second receiver with the first receiver and the satellite according to the code phase data, the synchronization data and the second receiver phase position, in which the sync phase position is a satellite phase position corresponding to one of a plurality of satellite time pulses of a satellite clock.

11. The time synchronization method of claim 9, wherein the synchronization data comprises a first phase offset between the sync phase position and the first receiver phase position, the time synchronization process further comprises a step of calculating a second phase offset between the sync phase position and the second receiver phase position by the second receiver according to the synchronization data.

12. The time synchronization method of claim 11, wherein the time synchronization process further comprises a step of generating a synchronized time pulse corresponding to the sync time pulse according to the first phase offset and the second phase offset.

13. The time synchronization method of claim 10, wherein the synchronization data further comprises a first receiver clock drift and a first receiver phase position difference between neighboring two of the first receiver time pulses and the second receiver obtains a second receiver phase position difference between neighboring two of the second receiver time pulses according to the tracking of the code phase data, the time synchronization method further comprises a step of calculating a second receiver clock drift by the second receiver according to the first receiver phase position difference and the second receiver phase position difference.

14. The time synchronization method of claim 9, further comprising a step of receiving rough position information of the second receiver relative to the first receiver by the second receiver from the network to compensate a distance offset of the time synchronization process.

15. The time synchronization method of claim 9, wherein the second receiver further obtains a frame sync data of the satellite from the satellite such that the second receiver performs the time synchronization process according to the code phase data, the synchronization data, the second receiver phase position and the frame sync data when a delay of the network is larger than a specific value.

16. The time synchronization method of claim 9, wherein the second receiver further obtains a frame sync data of the satellite from the satellite such that the second receiver performs the time synchronization process according to the code phase data, the synchronization data, the second receiver phase position and the frame sync data when a parity check of first word of the code phase data fails.

17. A portable electronic device used in a wireless communication system having a time synchronization mechanism, wherein the wireless communication system further comprises a receiver, the electronic device comprises:
a receiving unit for receiving a synchronization data from the receiver related to a sync phase position corresponding to one of a plurality of sync time pulses and receiver phase position corresponding to one of a plurality of receiver time pulses of a receiver clock;
a tracking unit for tracking a code phase data of a satellite to obtain an electronic device phase position corresponding to one of a plurality of electronic device time pulses of a device clock; and
a computing unit for computing a phase offset between the sync phase position and the electronic device phase position according to the code phase data, the synchronization data and the electronic device phase position to perform a time synchronization process.

18. The portable electronic device of claim 17, wherein the computing unit performs the time synchronization process with the receiver and the satellite according to the code phase data, the synchronization data and the electronic device phase position, in which the sync phase position is a satellite phase position corresponding to one of a plurality of satellite time pulses of a satellite clock.

19. The portable electronic device of claim 18, wherein the synchronization data further comprises a receiver clock drift and a receiver phase position difference between neighboring two of the receiver time pulses and the computing unit computes an electronic device phase position difference between neighboring two of the electronic device time pulses according to the tracking of the code phase data to further computes an electronic device clock drift according to the receiver phase position difference and the electronic device phase position difference.

20. The portable electronic device of claim 17, wherein the tracking unit further obtains a frame sync data of the satellite from the satellite such that the computing unit performs the time synchronization process according to the code phase data, the synchronization data, the electronic device phase position and the frame sync data when a parity check of first word of the code phase data fails.
